(19) United States
(12) Patent Application Publication
(10) Pub. No.: US 2016/0330535 A1
(43) Pub. Date: Nov. 10, 2016

(54) EAR-HANGING MICROPHONE

(71) Applicant: MASCOT ELECTRIC CO., LTD., Tainan City (TW)

(72) Inventor: Kun-Tien CHIANG, Tainan City (TW)

(21) Appl. No.: 14/704,486

(22) Filed: May 5, 2015

(51) Int. Cl. H04R 1/08

(52) U.S. Cl. CPC H04R 1/08

(57) ABSTRACT

An ear-hanging microphone is adapted to be worn on an ear of a user. The ear has an ear root that is connected to the user's head. The ear-hanging microphone includes a hanger, and a microphone that is connected to the hanger. The hanger includes a hook adapted to be hung on the ear root of the ear, and a pad adapted to resiliently abut against a depression portion of the ear root.

### FIELD

The disclosure relates to a microphone, and more particularly to an ear-hanging microphone.

### BACKGROUND

Referring to FIG. 1 and FIG. 2, a conventional ear-hanging microphone 1 is illustrated. The conventional ear-hanging microphone 1 is adapted to be worn on an ear 10 of a user and receive sound from a mouth (not shown) of the user. The ear 10 has an ear root 102 that is connected to the user's head. The conventional ear-hanging microphone 1 includes a hanger 11 adapted to be hung on the ear root 102, a microphone 12 connected to the hanger 11, and a cable 13 that is electrically connected to the hanger 11.

The hanger 11 includes a flexible hook 112 that is connected to the microphone 12 and adapted to be hung on the ear root 102, and a housing 111 that is electrically connected to the cable 13 and adapted to abut against the ear 10. Furthermore, the housing 111 contains inside an electric circuit (not shown) that electrically interconnects the microphone 12 and the cable 13, and is generally made of hard plastic. The microphone 12 includes a connecting part 122 that is flexible and electrically connected to the flexible hook 112, and a head 121 that is connected to the connecting part 122 and adapted to be close to the mouth.

To achieve a steady sound quality, the user may need to adjust a curvature of the flexible hook 112 so that the conventional ear-hanging microphone 1 settles closer around the ear root 102 and is prevented from wiggling loosely. However, such tight abutment of the housing 111 against the ear root 10 often causes discomfort to the user.

### SUMMARY

Therefore, an object of the disclosure is to provide an ear-hanging microphone that can be stably and comfortably worn on a user.

According to the disclosure, an ear-hanging microphone is adapted to be worn on an ear of a user. The ear has an ear root that is connected to the user's head. The ear-hanging microphone includes a hanger, and a microphone that is connected to the hanger. The hanger includes a hook adapted to be hung on the ear root of the ear, and a pad adapted to resiliently abut against a depression portion of the ear root.

### BRIEF DESCRIPTION OF THE DRAWINGS

Other features and advantages of the disclosure will become apparent in the following detailed description of the embodiment with reference to the accompanying drawings, of which:

FIG. 1 is a side view of a conventional ear-hanging microphone;

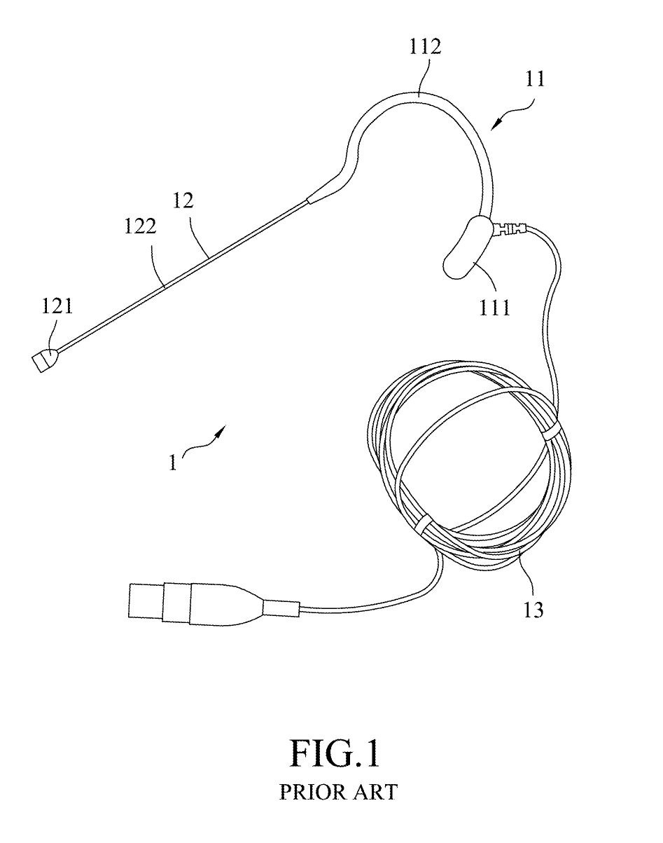

FIG. 2 is a side view illustrating the conventional ear-hanging microphone that is worn on an ear of a user;

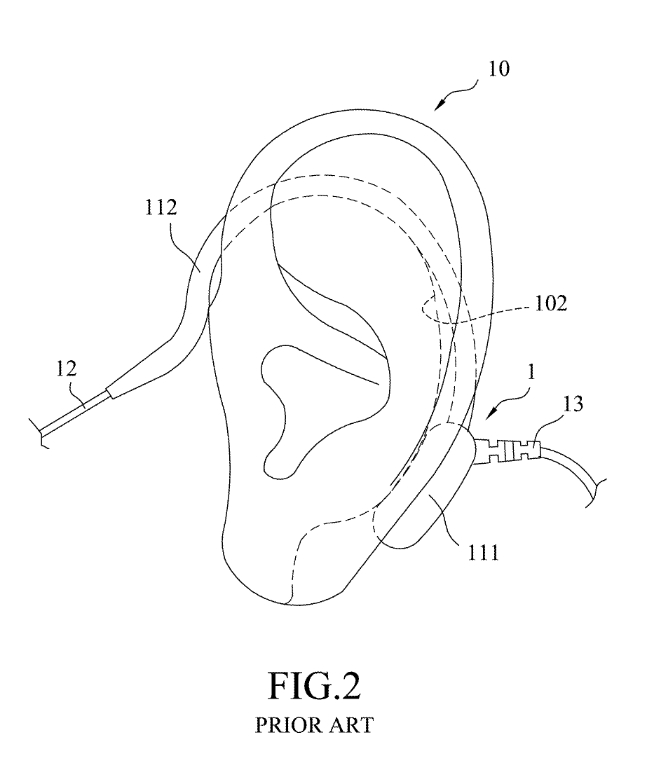

FIG. 3 is a side view illustrating an embodiment of an ear-hanging microphone according to the disclosure; and

FIG. 4 is a side view illustrating the embodiment that is worn on an ear of a user.

### DETAILED DESCRIPTION

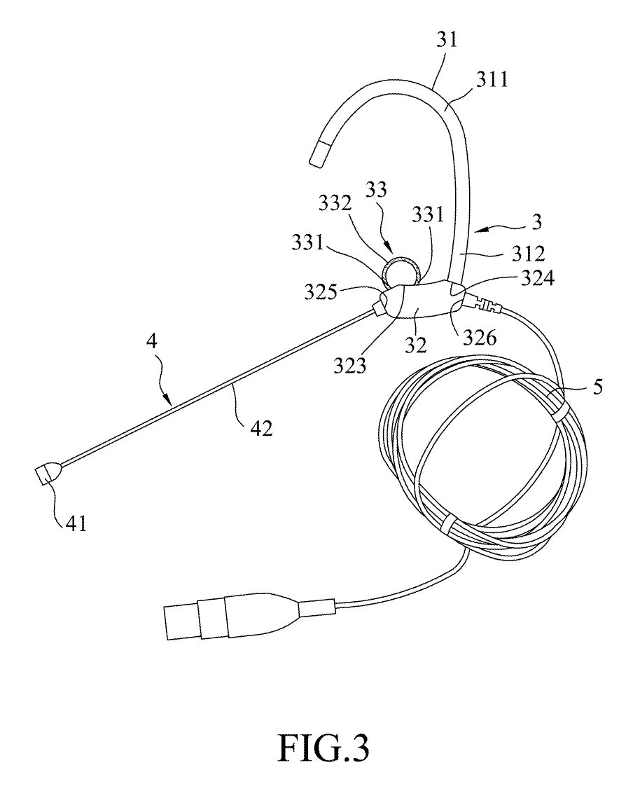

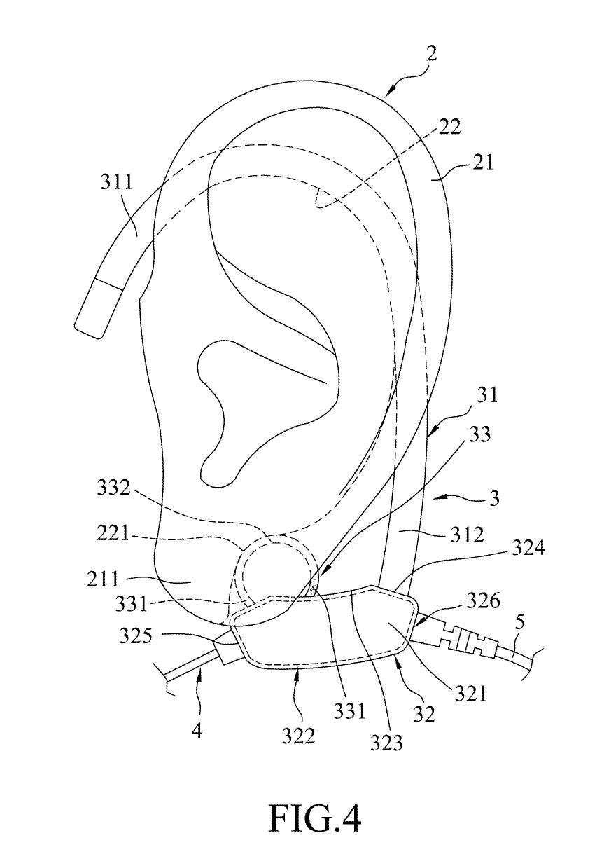

Referring to FIGS. 3 to 4, an ear-hanging microphone according to the disclosure is illustrated. The ear-hanging microphone is adapted to be worn on an ear 2 of a user. The ear 2 has an ear root 22 that is connected to the user's head. The ear-hanging microphone includes a hanger 3, a microphone 4 that is connected to the hanger 3, and a cable 5 that is electrically connected to the hanger 3.

The hanger 3 includes a hook 31 adapted to be hung on the ear root 22 of the ear 2, a pad 33 adapted to resiliently abut against a depression portion 221 of the ear root 22, and a housing 32 that interconnects the hook 31 and the pad 33. In this embodiment, the hook 31 has an arc section 311 adapted to be hung on an upper side of the ear root 22, and an extending section 312 extending from a rear end of the arc section 311 and adapted to be positioned behind a rear side of the ear root 22. The hook 31 is flexible for adjustment of a curvature thereof so as to change a tightness of attachment around the ear root 22. The depression portion 221 of the ear 2 is adjacent to an earlobe 211 which is connected to a lower side of the ear root 22.

The pad 33 has two connecting ends 331 spaced apart from each other, and a resilient abutment portion 332 that is disposed between the connecting ends 331 and adapted to abut against the depression portion 221 of the ear root 22. In this embodiment, the pad 33 of the hanger 3 is formed as a curved band, and made of an elastic material such as rubber or silica gel.

The housing 32 of the hanger 3 has two side walls 321 on two opposite sides thereof, and a surrounding wall 322 disposed between and connected to peripheries of the side walls 321. The surrounding wall 322 has a pad-connecting area 323 connected to the connecting ends 331 of the pad 33, a hook-connecting area 324 connected to the extending section 312 of the hook 31, a microphone-connecting area 325 opposite to the hook-connecting area 323, and a cable-connecting area 326 electrically connected to the cable 5. The housing 32 further has an electric circuit (not shown) within the side walls 321 and the surrounding wall 322 that electrically interconnects the microphone 4 and the cable 5.

The microphone 4 includes a head 41 for receiving sound, and a connecting part 42 that interconnects the head 41 and the microphone-connecting area 325. In this embodiment, the connecting part 42 is flexible for adjustment of a curvature thereof, and has a length sufficient enough to have the head 41 positioned close to a mouth of the user for receiving sound.

When wearing the ear-hanging microphone according to the disclosure, the user can hang the hook 31 of the hanger 3 on the upper and rear sides of the ear root 22, and bend the hook 31 to adjust the curvature thereof so that the pad 33 is brought to properly abut against the depression portion 221 of the ear root 22. As such, the pad 33 softly and resiliently contacts the ear root 22 when the hook 31 is tightly attached around the ear root 22, so that the user will not feel discomfort from abutment of the housing 32. However, it should be noted that the positions of the hook 31 and the pad 33 in relation to the ear 2 are not limited by this embodiment and may vary in actual implementation. For example, the pad 33 may abut against the upper side of the ear root 22, and the hook 33 may abut against the lower side of the ear root 22.

In a summary view of the described embodiment, by virtue of the elastic pad 33 of the hanger 3 that softly and resiliently abuts against the ear root 22 of the user, the user can comfortably wear the ear-hanging microphone according to the disclosure, even when the hook 31 of the hanger 3 is tightly attached around the ear root 22. Therefore, the ear-hanging microphone according to the disclosure can offer a stable and comfortable wearing experience for the user.

While the present invention has been described in connection with what is considered the exemplary embodiment, it is understood that this invention is not limited to the disclosed embodiment but is intended to cover various arrangements included within the spirit and scope of the broadest interpretation so as to encompass all such modifications and equivalent arrangements.

1. An ear-hanging microphone adapted to be worn on an ear of a user, the ear having an ear root that is connected to the user's head, said ear-hanging microphone comprising:
a hanger that includes a hook adapted to be hung on the ear root of the ear, and a pad adapted to resiliently abut against a depression portion of the ear root; and
a microphone that is connected to said hanger.

2. The ear-hanging microphone as claimed in claim 1, wherein:
said hanger includes a housing that interconnects said hook and said pad; and
one of said hook and said pad is adapted to contact an upper side of the ear root, and the other one of said hook and said pad is adapted to contact a lower side of the ear root.

3. The ear-hanging microphone as claimed in claim 1, wherein said pad of said hanger is formed as a band, and has two connecting ends spaced apart from each other, and a resilient abutment portion disposed between said connecting ends and adapted to abut against the depression portion of the ear root.

4. The ear-hanging microphone as claimed in claim 3, wherein:
said hanger further includes a housing that interconnects said hook and said pad and that has a pad-connecting area connected to said connecting ends of said pad; and
one of said hook and said pad is adapted to contact an upper side of the ear root, and the other one of said hook and said pad is adapted to contact a lower side of the ear root.

5. The ear-hanging microphone as claimed in claim 4, wherein:
said housing has two side walls on two opposite sides thereof, and a surrounding wall connected to peripheries of said side walls and having said pad-connecting area;
said surrounding wall further has a hook-connecting area connected to said hook, and a microphone-connecting area opposite to said hook-connecting area; and
said microphone includes a head for receiving sound, and a connecting part interconnecting said head and said microphone-connecting area.

6. The ear-hanging microphone as claimed in claim 5, wherein:
said surrounding wall of said housing of said hanger further has a cable-connecting area; and
said ear-hanging microphone further comprises a cable electrically connected to said cable-connecting area.
